(19) United States
(12) Patent Application Publication
(10) Pub. No.: US 2006/0144345 A1
(43) Pub. Date: Jul. 6, 2006

(54) Three-dimensional reflective collar with a tiered force releasable buckle and parasitic protection band support

(76) Inventors: Joseph Kover JR., Layton, UT (US); Scott L. Maxfield, Hooper, UT (US); Robert Ned Silvester, Logan, UT (US)

Correspondence Address: Joseph Kover, Jr., 947 North Aspen Way, Layton, UT, 84040, US

(21) Appl. No.: 11/029,762

(22) Filed: Jan. 6, 2005

(51) Int. Cl. A01K 27/00

(52) U.S. Cl. 119/865

(57) ABSTRACT

The present invention relates to a three-dimensional reflective cat collar whereby the three-dimensional reflective element is such as to promote the reflection of the light while the cat is in a position that is perpendicular to the headlights, such as while the cat is on a street, and also while the cat is in a position that is at an angle to the headlights, such as while the cat is approaching a street. The collar further serves to suppress overly long hair so that the three-dimensional reflective element remains visible. The present invention further relates to a tiered force releasable buckle whereby the tiered force releasable buckle is based upon a tiered weight class system which serves to place the feline into a specific weight class and that the release force of buckle is such as to correspond to the tiered weight class system.

### BACKGROUND OF THE INVENTION

Every evening thousands of family members are placed outside to freely roam between the hours of dusk to dawn. However, this action exposes these family members to the many dangers of the urban jungle, which include motor vehicles, fences, bushes, shrubs, and trees. Unfortunately, these family members are imperceptible to motorists, while either on the street or near the street, and consequently many of these family members fail to return home because either of their imperceptibility or because they have become entangled in a fence, bush, shrub, or tree. Tragically, these family members are either inadvertently struck by a motor vehicle or become a victim of strangulation and consequently either suffer a severe injury or become a fatality.

The present invention, in response to the aforementioned imperceptibility, relates to a three-dimensional reflective cat collar. The elements comprising the three-dimensional reflective collar are such as to promote the reflection of the light that is emitted from the headlights of an approaching motorist while the cat is in a position that is perpendicular to the headlights, such as while the cat is on a street, and also while the cat is in a position that is at an angle to the headlights, such as while the cat is approaching a street. The reflection of the light while the cat is in a position that is perpendicular to the headlights and also while the cat is in a position that is at an angle to the headlights would present an approaching motorist additional reaction time to avoid striking the forthcoming feline. The implementation of the three-dimensional reflective cat collar further suppresses the overly long hair of the feline so that the three-dimensional reflective elements continuously remain visible.

The present invention further relates to a tiered force releasable buckle whereby the feline is assigned to a weight class and the force that is required to release the buckle varies directly with the weight class of the feline. The implementation of a tiered force releasable buckle accommodates the various feline weight classes and therefore averts possible entrapment, strangulation, or injury should the cat become entangled in an obstacle. Furthermore, the present invention could also include a means for the incorporation of a parasite protection band.

The prior art of lighted safety collars is well known as such art is revealed in (U.S. Pat. No. 6,394,040 B1 May 2002) whereby Axel submits a lighted pet safety collar, while a second system (U.S. Pat. No. 5,140,946 August 1992) whereby Pennock and Pennock submits a illuminated pet collar. A third system (U.S. Pat. No. 5,074,251 December 1991) Pennock and Pennock also submits an illuminated pet collar, while (U.S. Pat. No. 4,895,110 January 1999) LoCascio reveals a fourth system. The first liability associated with these four systems is that all four systems require a power source since these systems are comprised of active elements. Consequently, a light-emitting element would quickly drain the power source as acknowledged in U.S. Pat. No. 6,394,040 B1. However, U.S. Pat. No. 6,394,040 B1, in the background of the invention, contradicts this acknowledged liability by the introduction of a second light-emitting element. The two light-emitting elements double the load placed on the power source whereby the second light-emitting element approximately would double the discharge rate of the power source. A second liability associated with these four systems is that human beings, by nature, become complacent whereby the advantage of these systems would be lost if the caretaker should fail to replace the discharged power source. The advantage of these systems would also be lost if the power source should become discharged while the feline is outside. A third liability associated with these four systems is the concept of “one size fits all” whereby U.S. Pat. No. 6,394,040 B1 acknowledges that such systems may become obscured by the overly long hair of the pet. However, these systems fail to address the obstruction of either the light-emitting elements or the reflective elements by overly long hair. The design of the collar should be such that it suppresses the overly long hair so that either the light-emitting elements or the reflective elements remain visible and that it can be effortlessly worn by the feline. An additional liability that is associated with all four systems is that they include a switching means to activate and deactivate the system. Once again, the advantage of these systems would be lost if the caretaker should fail to activate the units. Another liability that is associated with all four systems is that the feline would be exposed to serious injury should the chemicals contained in the battery seep onto the cat.

The prior art of reflective safety collars is also well known as such art is revealed in (U.S. Pat. No. 5,970,921 October 1999) whereby Fulton submits a multi-function pet collar, while Colliard submits a second system (U.S. Pat. No. 4,091,766 May 1978) a pet collar. The first liability associated with these two systems is the concept of “one size fits all” whereby the reflective element may become obscured by the overly long hair of the feline. Again, the design of the collar should be such that it suppresses the overly long hair so that either the light-emitting elements or the reflective elements remain visible and that it can be effortlessly worn by the feline. A second liability associated with these two systems is that both systems are such as to exclusively promote the reflection of the light that is emitted from the headlights of an approaching motorist while the cat is in a position that is perpendicular to the headlights, such as while the cat is on a street, and fails to promote the reflection of light while the cat is in a position that is at an angle to the headlights, such as while the cat is approaching a street. A further liability that is unique to U.S. Pat. No. 5,970,921 is that this system is impractical for the feline species in that it would present considerable discomfort to the feline.

The prior art of a releasable buckle when exposed to a preset force is also well known as such art is revealed in (U.S. Pat. No. 6,360,404 B1 March 2002) whereby Mudge and Wood submit a break-away buckle, while a second system while Mudge (U.S. Pat. No. 5,791,297 August 1998) submits a dog collar designed to prevent entrapment strangulation or injury. A third system (U.S. Pat. No. 5,701,849 December 1997) Suchowski and Carroll submits a device including buckle means for release of a pet collar, while a fourth system (U.S. Pat. No. 5,443,039 August 1995) Suchowski submits a releasable cat collar. A fifth system (U.S. Pat. No. 5,322,037 June 1994) Tozawa submits a collar for a cat, while a sixth system (U.S. Pat. No. 5,050,538 September 1991) Gurski, Jr. submits a break-away pet collar. Subsequently, (U.S. Pat. No. 4,917,049 April 1990) Peterson submits a seventh system, a safety releasable collar for animals, while (U.S. Pat. No. 4,881,492 November 1989) Jones submits an eighth system, a break-away collar coupling. (U.S. Pat. No. 4,480,589 November 1984) Schneider submits a ninth system, a safety collar device while (U.S. Pat. No. 4,426,957 January 1984) Horrigan submits a tenth system, a safety release pet collar, and (U.S. Pat. No. 4,180,016 December 1979) George submits an eleventh system, a safety pet collar.

The first liability associated with these eleven systems is the concept of “one size fits all” which adopts a specific preset release force. Consequently, this approach states that an adult feline whose weight is six pounds exerts the same force as an adult feline, such as a Turkish Van, whose weight can be in excess of twenty pounds. Unfortunately, this statement defies the law of physics, which states that the force exerted by an object is directly proportional to the mass of an object. Consequently, if the specific preset release force were set at twenty pounds the adult feline whose weight is six pounds, when entangled, may suffer a severe or a fatal injury, while an adult feline whose weight is twenty pounds may exert sufficient force to where a collar with a specific preset release force of ten pounds would inadvertently release and the advantage of either the light-emitting collar or the reflective collar would be lost. A second liability associated with these eleven systems is that the properties of plastics and rubber are significantly altered with temperature. Consequently, the minimal release force of the buckle would also be significantly altered to where the feline may suffer a severe or a fatal injury. Instead, the properties of the buckle should remain constant throughout a broad temperature range so that the buckle would release at the specific preset force and avert a severe or fatal injury. Another liability unique to (U.S. Pat. No. 5,050,538) and (U.S. Pat. No. 4,426,957) is that these two systems employ Velcro to establish the specific preset force to release the collar. However, the properties of Velcro are such that hair and fur easily become embedded within the Velcro, which would significantly alter the specific preset release force of the collar.

The prior art of a variable force releasable buckle when exposed to the preset force is also well known as such art is revealed in (U.S. Pat. No. 5,450,820 September 1995) whereby Kirsch submits a quick release dog collar, while a second system Miller (U.S. Pat. No. 4,044,725 August 1977) submits a pet collar. The liability that is associated with (U.S. Pat. No. 5,450,820) is that the means to alter the preset force is comprised of a plurality of interchangeable springs of various resiliencies. However, the accuracy of the preset force is significantly affected by outside variables. One outside variable is the friction of the spring against the cylinder wall, whereby the friction alters the release force of the buckle. A second outside variable is whereby liquid such as rain and the residual mineral deposits associated with said liquid would increase the friction of the spring against the cylinder walls and significantly increase the release force of the buckle. The liability that is associated with (U.S. Pat. No. 4,044,725) is that the means to alter the preset force is comprised of a screw portion that secures the separate ball and socket parts. However, the accuracy of the preset release force would prove to be extremely obstinate.

The three-dimensional reflective collar serves resolve the imperceptibility liabilities which are associated with the prior art, whereby the three-dimensional collar promotes the reflection of the light that is emitted from the headlights of an approaching motorist while the cat is in a position that is perpendicular to the headlights, such as while the cat is on a street; and also while the cat is in a position that is at an angle to the headlights, such as while the cat is approaching a street. The reflection of the light while the cat is in a position that is perpendicular to the headlights and while the cat is in a position that is at an angle to the headlights would present an approaching motorist additional reaction time to avoid striking the approaching feline. The three-dimensional reflective collar also considers the various hair lengths of the feline, such that the reflective elements remain visible regardless of the hair length. In addition, the three-dimensional collar includes a tiered force releasable buckle whereby the force that is required to release the buckle is directly proportional to the weight class of the cat. The implementation of a tiered force releasable buckle would serve to avert possible entrapment, strangulation, or injury should the cat become entangled in an obstacle. The three-dimensional reflective safety collar could also include a means for the incorporation of a parasite protection band.

### SUMMARY OF THE INVENTION

The present invention relates to a three-dimensional reflective cat collar whereby the three-dimensional reflective element is such as to promote the reflection of the light while the cat is in a position that is perpendicular to the headlights, such as while the cat is on a street, and also while the cat is in a position that is at an angle to the headlights, such as while the cat is approaching a street. The reflection of the light while the cat is in a position that is perpendicular to the headlights and while the cat is in a position that is at an angle to the headlights would present an approaching motorist additional reaction time to avoid striking the forthcoming feline. The design of the three-dimensional reflective cat collar further serves to suppress the overly long hair of the feline whereby the width of the collar is directly proportional to the size of the feline and the three-dimensional reflective elements remain visible. Furthermore, the design of the three-dimensional is such that it can be effortlessly worn by the feline.

The present invention further relates to a tiered force releasable buckle whereby the force that is required to release the buckle is directly proportional to the weight class of the feline. The implementation of a tiered force releasable buckle, which directly varies with the weight class of the feline, would serve to avert possible entrapment, strangulation, or injury should the cat become entangled in an obstacle. The concept of “one size fits all” which adopts a specific preset release force has one major flaw wherein this approach states that an adult feline whose weight is six pounds exerts the same force as an adult feline, such as a Turkish Van, whose weight can be in excess of twenty pounds. Unfortunately, this statement defies the law of physics, which states that the force exerted by an object is directly proportional to the mass of an object. Consequently, if the specific preset release force were set at twenty pounds the adult feline whose weight is six pounds, when entangled, may suffer a severe or a fatal injury, while an adult feline whose weight is twenty pounds may exert sufficient force to where a collar with a specific preset release force of ten pounds would inadvertently release and the advantage of either the light-emitting collar or the reflective collar would be lost. Furthermore, the properties of the buckle should remain constant throughout a broad temperature range so that the buckle releases at the preset tiered force and averts a severe or fatal injury. The reflective safety collar could also include a means for the incorporation of a parasite protection band.

### BRIEF DESCRIPTION OF THE DRAWINGS

FIG. 1 reveals the three-dimensional reflective collar whereby the three-dimensional reflective elements are such as to promote the reflection of the light while the cat is in a position that is perpendicular to the headlights, such as while the cat is on a street, and also while the cat is in a position that is at an angle to the headlights, such as while the cat is approaching a street. FIG. 1 further reveals the tiered force releasable buckle whereby the force required to release the buckle is directly proportional to the weight class of the feline, the attachment means of the tiered force releasable buckle to the three-dimensional reflective collar, the means for the incorporation of a parasite protection band, a means to secure the excess adjustment band, and the means to support the attachment of a leash, tags or a bell.

FIG. 2 reveals a cross sectional view of the three-dimensional reflective collar element whereby the three-dimensional reflective element is such as to promote the reflection of the light while the cat is in a position that is perpendicular to the headlights, such as while the cat is on a street, such as while the cat is on a street, and also while the cat is in a position that is at an angle to the headlights, such as while the cat is approaching a street. The cross sectional view further reveals whereby the width of the three-dimensional collar is directly proportional to the size of the feline, which serves to suppress the overly long hair of the feline so that the three-dimensional reflective elements remain visible. Further revealed is the element which serves to establish the three-dimensional form so that it can be effortlessly worn by the feline.

FIG. 3 reveals the attachment means and the adjustment means of the male element and the female element of the tiered force releasable buckle to the three-dimensional reflective cat collar element, the attachment means of the tiered force releasable buckle to the three-dimensional reflective collar element, a means to secure the excess adjustment band, and the means to support the attachment of a leash, tags or a bell.

FIG. 4 reveals the male element and the female element of the tiered force releasable buckle, the attachment means of the tiered force releasable buckle to the three-dimensional reflective collar element and the means to establish the buckle release force such that the force varies directly with the weight class of the feline.

### DETAILED DESCRIPTION OF THE PREFERRED EMBODIMENT

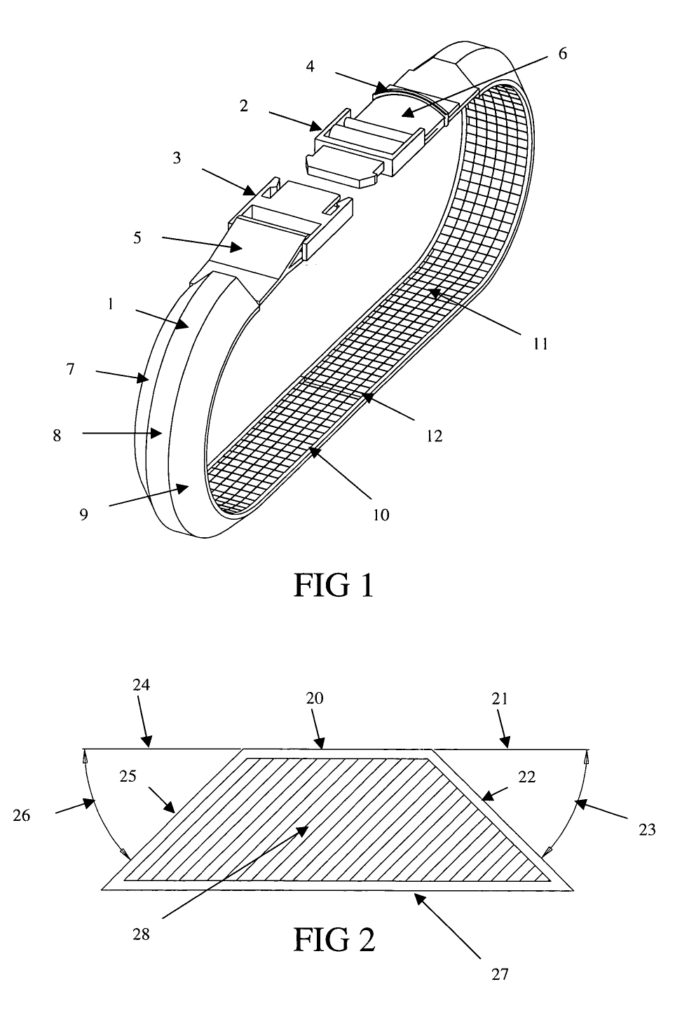

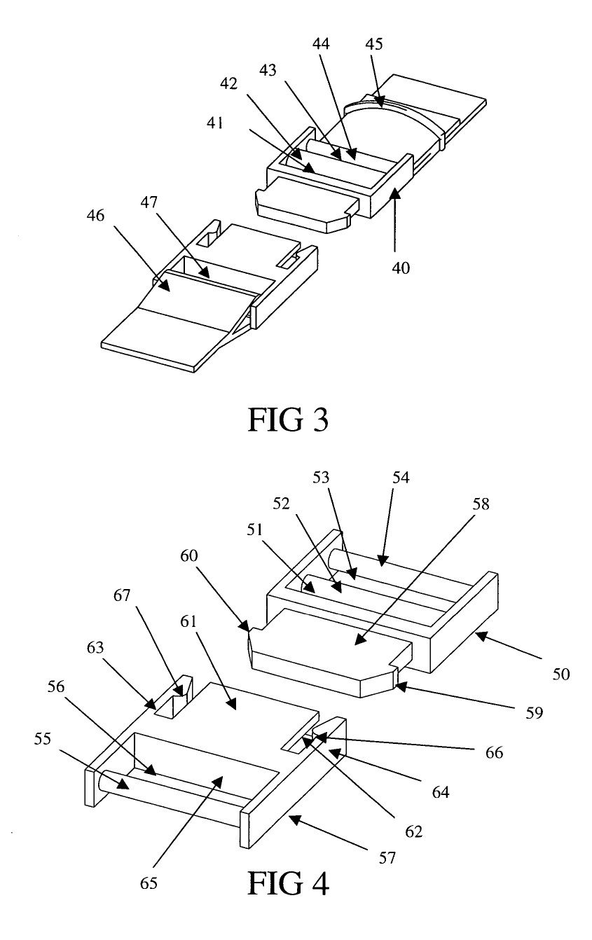

The drawings shown in FIG. 1, FIG. 2, FIG. 3, and FIG. 4 for the preferred embodiment of the three-dimensional reflective cat collar, the tiered force releasable buckle, and parasitic protection band support will now be addressed in complete detail.

FIG. 1 reveals the embodiment according to the invention of a three-dimensional reflective cat collar comprised of a three-dimensional reflective element 1, a tiered force releasable buckle with a male element 2 and a female element 3, and a parasitic protection band support means 11. The reflective element of the three-dimensional reflective cat collar is comprised of the three reflective elements 7, 8, and 9 whereby element 7 is such as to promote the reflection of the light while the cat is in a position that is perpendicular to the headlights, such as while the cat is on a street and elements 8 and 9 are such as to promote the reflection of the light while the cat is in a position that is at an angle to the headlights, such as while the cat is approaching a street. A fourth element 10, which can be comprised of either a reflective or non-reflective material, is secured to the two reflective elements 7 and 9 by means of stitching or the like. The reflective elements 7, 8, and 9 further could be inscribed with a permanent reflective substance, which could comprise an arrangement of letters or words that would serve to reveal, to an approaching motorist, the presence of a pet such as while the cat is on a street or such as while the cat is approaching a street.

FIG. 1 further reveals a tiered force releasable buckle with a male element 2 and a female element 3 whereby the force required to release the buckle is directly proportional to the weight class of the feline. Further revealed in FIG. 1 is an attachment means whereby the three-dimensional reflective cat collar is attached to the first end of the adjustment band 6 by means of stitching or the like. FIG. 1, in conjunction with FIG. 3, and FIG. 4 reveal the attachment means of the adjustment band 6 to the tiered force releasable buckle male element 2 of FIG. 1, the male element 40 of FIG. 3, or the male element 50 of FIG. 4, and the adjustment means of band 6 whereby the adjustment band 6 is first passed under the guide 42 of FIG. 3 of the male element 40 or under the guide 52 of FIG. 4 of the male element 50, through the opening 41 of FIG. 3 or through the opening 51 of FIG. 4, over the guide 42 of FIG. 3 or over the guide 52 of FIG. 4. The adjustment band 6 is then folded back and passed through the opening 43 of FIG. 3 or through the opening 51 of FIG. 4, and under the guide 44 of FIG. 3 or under the guide 54 of FIG. 4, whereby the excess adjustment band is secured by means of a loop 4 of FIG. 1 or a loop 45 of FIG. 3 which is secured to the first end of the adjustment band 6 by means of stitching or the like and serves to support the attachment of a leash, tags, or a bell. Further revealed in FIG. 1 is the attachment means of the three- dimensional reflective cat collar 1 to the tiered force releasable buckle female element 3 whereby the first end of the attachment band 5 is passed under the guide 46 of FIG. 3 or under the guide 55 of FIG. 4, through the opening 47 of FIG. 3 or through the opening 56 of FIG. 4. The attachment band 5 is then folded back to the second end of the attachment band 5 and secured to the three-dimensional reflective cat collar 1 by means of stitching or the like. FIG. 1 also reveals a means for the incorporation of a parasite protection band which is comprised of a protection band support mesh 11 that is secured to the fourth element 10 of the three-dimensional reflective cat collar by means of stitching or the like. FIG. 1 further reveals whereby the protection band support mesh 11 includes an aperture 12.

The incorporation of the parasite protection band is accomplished by inserting the first end of the parasite protection band into the aperture 12 of the parasite protection band support mesh 11. The first end of the parasite protection band is then positioned to one end of the three-dimensional reflective cat collar 1. The second end of the parasite protection band is then inserted into the aperture 12 of parasite protection band support mesh 11 and positioned at the opposite end of the three-dimensional reflective cat collar 1.

FIG. 2 reveals a cross sectional view of the three-dimensional reflective collar whereby the three-dimensional reflective elements are such as to promote the reflection of the light while the cat is in a position that is perpendicular to the headlights, such as while the cat is on a street, and also while the cat is in a position that is at an angle to the headlights, such as while the cat is approaching a street. The first reflective element 20 is such as to promote the reflection of the light while the cat is in a position that is perpendicular to the headlights, such as while the cat is on a street. FIG. 2 further reveals a second reflective element 22 which is such as to promote the reflection of the light while the cat is in a position that is at an angle to the headlights, such as while the cat is approaching a street. The relationship of the first reflective element 20 to the second reflective element 22 is such that it is at an angle of descent 23 from a line 21 that is extended along the surface of the first reflective element 20. Also, FIG. 2 reveals a third reflective element 25 which also is such as to promote the reflection of the light while the cat is in a position that is at an angle to the headlights, such as while the cat is approaching a street. The relationship of the first reflective element 20 to the third reflective element 25 is such that it is at an angle of descent 26 from a line 24 that is extended along the surface of the first reflective element 20. The cross sectional view of FIG. 2 further reveals a fourth element 27 whereby the relationship of the fourth element 27 is such that it is a given distance from the first reflective element 20 and parallel to the first reflective element 20. FIG. 2 further reveals whereby the width of the fourth element is directly proportional to the size of the feline and serves to suppress the overly long hair of the feline so that the three-dimensional reflective elements 20, 22, and 25 remain visible.

Further revealed in FIG. 2 is a fifth element 28 that serves to establish the three- dimensional form. The fifth element 28 is comprised of a lightweight, soft, and pliable material such as foam rubber, latex foam, or the like whereby the fifth element 28 serves a dual mean. First, the fifth element 28 serves to establish the three-dimensional form and should the movements of the feline deform the shape of the three-dimensional collar, the material of the fifth element 28 would serve to restore original form. Second, the properties of the fifth element 28 are such that the collar allows the feline to move without restraint so that it can be effortlessly worn by the feline.

FIG. 4 reveals the male element 50 and the female element 57 of the tiered force releasable buckle and the means to establish the force required to release the buckle such that the force varies directly with the weight class of the feline. Furthermore, the tiered force releasable buckle is comprised of a metal alloy or the like, such that the properties remain constant through out a broad temperature range. Also revealed in FIG. 4 is the attachment means, which was previously described in detail, of the tiered force releasable buckle to the three-dimensional reflective cat collar which is comprised of openings 51 and 53 and guides 52 and 54 for the male element 50, and opening 56 and guide 55 for the female element 57. FIG. 4 also reveals whereby the male element 50 of the tiered force releasable buckle further includes a flat base slide 58 with two latching mechanisms 59 and 60 and the female element 57 which is comprised of four exterior walls 61, 62, 63, 64 and one interior wall 65. Also revealed in FIG. 4 is the relationship of the four exterior walls 61, 62, 63, 64 and the one interior wall 65 whereby the relationship is such that the interior wall 65 is perpendicular to the four exterior walls 61, 62, 63, and 64, while the exterior wall 60 is parallel to the exterior wall 63, and the exterior wall 61 is parallel to the exterior wall 62.

The connection means of the male element 50 to the female element 57 in FIG. 4 is such that the flat base slide 58 of the male element is inserted into the four exterior walls 61, 62, 63, and 64 of the female element 57 whereby the exterior walls 61 and 62 serve as a guide to the flat base slide 58. The exterior walls 63 and 64 flex to accommodate the two latching mechanisms of the flat base slide 58, and the interior wall 65 serves as a stop for the male flat base slide 58. As the flat base slide reaches the interior wall 65 the two latching mechanisms 59 and 60 engage with the two corresponding convex locking mechanisms 66 and 67. The engagement of the two latching mechanisms 59 and 60 with the two convex locking mechanisms 66 and 67 secures the male element 50 to the female element 57 of the tiered force releasable buckle. Furthermore, the dimensions of the flat base slide 58 of the male element 50 are such as to firmly engage into the four exterior walls 61, 62, 63, and 64 of the female element 57.

The tiered force release means is such that the force required to release the buckle is directly proportional to the weight class of the feline whereby the weight class of the feline is such that the A weight class is less than or equal to X pounds which would be associated to tiered force releasable buckle S, the B weight class is greater than X pounds and less than or equal to Y pounds which would be associated to tiered force releasable buckle M, and the C weight class is greater than Y pounds and less than, equal to, or greater than Z pounds which would be associated to tiered force releasable buckle L. Therefore the force required to release buckle S would be equal to or greater than X pounds, while the force required to release buckle M would be equal to or greater than Y pounds, and the force required to release buckle L would be equal to or greater than Z pounds. Therefore, should the collar of the feline become entangled the latching mechanisms 59 and 60 of the flat base slide 58 would exert a force onto the convex locking mechanisms 66 and 67 of the two exterior walls 63 and 64. The width of these two exterior walls 63 and 64 are such that the release point is at X pounds for buckle S, Y pounds for buckle M, and Z pounds for buckle L.

It is understood that FIG. 1 and FIG. 2 illustrates the implementation of the three-dimensional reflective cat collar in an explicit form. The three-dimensional reflective cat collar, however, could also have been realized by any three-dimensional form such as a triangular form, a circular form, an elliptical form, a rectangular form, pentagon, hexagon, octagon, or the like. However, these forms would offer no improvement in the reflection of the headlights either while the cat is in a position that is perpendicular to the headlights, such as while the cat is on a street, or while the cat is in a position that is at an angle to the headlights, such as while the cat is approaching a street. The three-dimensional reflective cat collar could also have been realized by means of three-dimensional light emitting elements and a power source. However, this also would offer no improvement in the perceptibility of the feline.

The originality of the art form is three-dimensional reflective element whereby the reflective elements are such as to promote the reflection of the light while the cat is in a position that is perpendicular to the headlights, such as while the cat is on a street, and also while the cat is in a position that is at an angle to the headlights, such as while the cat is approaching a street. Further originality extends to the suppression of the overly long hair of the feline so that the three-dimensional reflective elements 20, 22, and 25 remain visible

It is further understood that FIG. 3 and FIG. 4 illustrates the implementation of the tiered force releasable buckle by means of an explicit mechanical system. The release means of the tiered force releasable buckle, however, could also have been realized by any other mechanical means.

The originality of the art form is whereby the tiered force releasable buckle is based upon a tiered weight class system which serves to place the feline into a tiered weight class and whereby the tiered release force of the buckle is such as to correspond to tiered weight class system.

It is also understood that the application of the three-dimensional reflective collar can further be extended to include all domestic pets and domestic livestock.

What is claimed:

1. A three-dimensional reflective collar comprising:
a means to establish a three-dimensional form;
a connection means.

2. The three-dimensional reflective collar according to claim 1, whereby the three-dimensional reflective means is arranged such as to promote the reflection of the light while the pet is in a position that is perpendicular to a headlight and also while the pet is in a position that is at an angle to a headlight.

3. The three-dimensional reflective collar according to claim 1 whereby the means to establish the three-dimensional form is pliable such that the original form is restored should the movement of a pet deform the original form of the pet collar.

4. The three-dimensional reflective collar according to claim 1, whereby the width of the three-dimensional cat collar is directly proportional to the size of the feline and serves to suppress the overly long hair of the feline so that the three-dimensional reflective elements remain visible.

5. A tiered force releasable buckle comprising:
a male element connected to a first end of a collar;
a female element connected to a second end of a collar;
a connection means of the male element to the female element;
a tiered weight class system.

6. The tiered force releasable buckle according to claim 5 whereby the release force is such as to correspond to a specific weight class.

7. The tiered force releasable buckle according to claim 5 whereby the material, which comprises the tiered force releasable buckle, is such that the properties remain constant through out a broad temperature range.
